(19) United States
(12) Patent Application Publication
(10) Pub. No.: US 2020/0331074 A1
(43) Pub. Date: Oct. 22, 2020

(54) QUICK-ADJUSTMENT FINISHING TOOL AND METHOD OF USE

(71) Applicant: William J. Endres, Houghton, MI (US)

(72) Inventor: William J. Endres, Houghton, MI (US)

(73) Assignee: EIP Holdings, LLC, Houghton, MI (US)

(21) Appl. No.: 16/849,907

(22) Filed: Apr. 15, 2020

Related U.S. Application Data
(60) Provisional application No. 62/834,399, filed on Apr. 16, 2019.

(51) Int. Cl. B23C 3/13

(52) U.S. Cl. CPC B23C 3/13

(57) ABSTRACT

This invention relates to finish machining, including a tool and the method of its use. Embodiments of this invention allow a cutting insert to be indexed quickly without loosening the insert retainer (screw or clamp) and not changing the depth-of-cut position of the tooth tip. The indexing motion is achieved by rotating a rotor, either manually or by way of a motor included on the tool. In some cases, between indexes, a small angle may be imparted to the rotor in order to adjust slightly the depth-of-cut position of the tooth tip in order to compensate for it being worn, or in other cases to precisely match the depth of cut of the tooth tips on multiple cutting teeth. The method involves setting up the path the tool will follow, then setting the feed per finishing tooth to be unconventionally large relative to the maximum depth of cut along the path. Using a round cutting insert, in particular a tangentially-mounted one or one that exhibits comparable curved edge profile, provides a large tooth-tip radius of curvature which in turn results in a good/smooth surface finish in spite of the unconventionally high feed per finishing tooth.

### CROSS-REFERENCE TO RELATED APPLICATION

This application is based upon and claims priority to and the benefit of U.S. provisional application Ser. No. 62/834,399 filed Apr. 16, 2019, the disclosures of which are hereby incorporated in their entirety by reference herein.

### BACKGROUND OF THE INVENTION

The invention addresses cutting tools used to remove material such as from a workpiece by way of a machining process. The process of machining acts on a workpiece to remove an existing, often but not always un-machined, surface, in order to create a new surface and, in doing so, producing chips of removed material. The process involves providing, by a machine tool on which the process takes place, a relative cutting motion between a cutting tool, comprising a body and one or more cutting teeth, and a workpiece, in order for material to be removed from the workpiece by the cutting tool. The rate associated with the cutting motion is referred to as the cutting speed or the surface speed and is generally measured in feet per minute or meters per minute. We limit our consideration here to machine tools that provide the cutting motion by way of a spindle rotating either the cutting tool or the workpiece at a spindle speed measured in, for instance, revolutions per minute.

To accomplish material removal, at least one cutting tooth, inclusive of a cutting insert and at times also referred to here simply as a cutting insert, must physically (mechanically) engage with the workpiece to remove a thin layer of material in order to create a new surface. The new surface is created by the furthest protruding points (in the depth of cut direction) on the furthest protruding cutting insert(s), each furthest protruding point on each cutting insert being referred to here as its tooth tip. The noted engagement between the cutting tool and the workpiece is accomplished by setting the position of the cutting insert(s) relative to the workpiece, specifically setting the tooth tip on the cutting edge of each cutting insert to its depth-of-cut position. This is achieved by way of setting the position of the cutting tool relative to the workpiece, to define a depth of cut (aₚ) that is measured normal to the new surface to be created. Further, the machine provides a feeding motion of the cutting tool relative to the workpiece that is characterized by a feed speed. Often times the total depth of material to be removed (a_{p,total}) in producing the new surface is greater than can be removed with a single pass of the cutting tool in which case multiple passes of the cutting tool are made, each pass i at a depth of cut a_{p,i}, such that the summation of a_{p,i}, i=1 to P, removes a_{p,total} in P passes. The depth of cut for each pass (a_{p,i}) may or may not be equal to that of any other pass a_{p,j}. It is common, though not a requirement, for a_{p,total} to be divided equally, resulting in P passes of equal depth of cut (a_{p,i}=a_{p,total}/P, i=1 to P). However, it is also common to desire a final or finishing pass to occur at different conditions, whether a different depth of cut and/or feed or/or speed. In this case, there is a final/finishing pass at depth of cut a_{p,P} and P−1 passes of other depths of cut, again, often of equal depth of cut (a_{p,i}=(a_{p,total}−a_{p,P})/(P−1), i=1 to P−1).

The cutting tool feeding motion for each pass generally traces a path that corresponds to the new surface with an offset from the tooth tip of each cutting insert measured normal to the new surface, the difference in that offset between successive passes being the aforementioned depth of cut for the respective pass i (a_{p,i}). With the exception of the P^{th} pass where the offset equals zero at all points on the path, in spite of the general approach noted above, in practice the offset of any one pass may vary along the path, whether a result of the varying offset along the tool path, or for other reasons. The feeding motion is characterized by a feed per revolution, which is the change in position of the cutting tool relative to the workpiece along the path, that change in position occurring over the time elapsing between subsequent traversings of any particular cutting insert through any angle of cutting rotation, specifically 360 degrees for the feed per revolution. When there is more than one cutting insert spaced circumferentially around the cutting tool and set at substantially the same depth of cut, the feeding motion is further characterized by a feed per tooth. The feed per tooth, or feed per insert as the case may be, is the change in position of the cutting tool relative to the workpiece along the path, that change in position occurring over the time elapsing between subsequent cutting inserts at the similar depth of cut traversing any angular position of cutting rotation, specifically the spacing between the noted subsequent cutting inserts.

The types of machining processes where the present invention and aforementioned speed, feeding motion, and depth-of-cut/offsets/surfaces/paths etc. applies include those that employ a non-rotating tool. This includes lathe processes where the outer diameter of the workpiece is machined, often referred to as OD turning, or the inner diameter of the workpiece is machined, often referred to as ID turning or lathe-boring, or the end is machined, often referred to as facing. In contrast, there are other machining processes where the tool rotates and the workpiece does not rotate. This includes processes like face milling, peripheral milling, and cylinder boring. The present invention can apply in those as well in both method and device.

A machining operation commences when a cutting tool engages a surface on a workpiece and concludes when that same cutting tool disengages the workpiece, generally being preceded by and followed by rapid traverses. In an abstract sense, each pass noted above may be considered a machining operation, while at the same time the accumulation of passes are often considered to comprise what is referred to as a machining operation. A final or finishing pass, the P^{th} pass noted earlier, often referred to as a finishing operation, is of primary interest in the present invention. Likewise, the present invention applies to cases where some inserts on the cutting tool are cutting at a greater offset from the new surface than others for which the offset of their tooth tips from the new surface are zero; that is, the latter are finishing cutting teeth or finishing inserts. Thus, a finishing insert is any cutting insert that is responsible for (ultimately contributes to) creating the dimension, that is, the position of the new surface relative to another reference surface, and the roughness of the new surface. There may be one or more than one finishing inserts, as noted. Furthermore, all inserts on a cutting tool may be (intended/purposed as) finishing inserts, and some inserts may be (intended/purposed) as inserts that do not contribute to the actual final surface. Finishing inserts, in fact any cutting insert, be it finishing or not, may be of various shapes such as but not limited to triangular, square, rectangular, rhombic, pentagonal, hexagonal, octagonal, and round. Finishing inserts, for the purpose of creating a good/low surface roughness, may have a higher radius of curvature on the cutting edge, as measured at the tooth tip, than other inserts might.

Round cutting inserts are a natural way of accomplishing a large cutting edge radius of curvature at the tooth tip. Like other cutting inserts, round cutting inserts can be of a type mounted in a conventional “radial mount” or in a “tangential mount.” The difference between these mountings relates to the orientation of the insert axis relative to the tool body and the direction of cutting motion. In other words, the mounting type relates to which surface on the cutting insert is the flank surface that provides clearance relative to the new surface created, and which surface on the cutting insert is the rake surface on which the chip of removed material is formed. Regardless of insert shape, these two surfaces, the rake surface and flank surface, exist and form the cutting edge at their intersection. A round insert, by definition, exhibits a substantially round or circular cutting edge.

A conventional radial-mount configuration is shown in FIG. 1 (a face milling tool as an example). The tool comprises a body 1 and, in this example, has three round cutting inserts 2 each having an insert axis 3. In a radial mount, the flank surface 6 is the peripheral surface 4 and the rake surface 7 is one of the end surfaces 5. This type of configuration is the subject of numerous patents, such as U.S. Pat. No. 2,885,766A and 3,329,065. A tangential-mount configuration is shown in FIG. 2 (a face milling tool as an example) where the rake surface 7 is the peripheral surface 4 and the flank surface 6 is one of the end surfaces 5. This type of configuration is the subject of numerous patents, such as U.S. Pat. Nos. 2,127,523 and 2,233,724 for single-point lathe processes used to create surfaces of revolution and more recently U.S. application Ser. No. 16/266,883 for a variety of multi-tooth processes. In both examples the circular intersection of the flank surface 6 and the rake surface 7 defines the round or circular cutting edge 8, located on which is the tooth tip 9.

While radial or tangential mounting of a round cutting insert may be stationary, these four aforementioned patents cover examples of tools that allow the insert to rotate under the forces of chip formation. This allows the edge to be continually refreshed for extended life between servicing the tool to account for tool (cutting insert) wear. When the need for a fine finish is present, a rotating cutting insert may not produce the required surface roughness/finish due to even slight runout or wobble of the rotating cutting insert that is present in any practical implementation of a rotating cutting insert. For this reason, a round cutting insert used as a finishing insert may require it to be fixed (non-rotating). This provides the benefit of a large radius of curvature as noted. That radius of curvature is even greater in a tangential mount, making it particularly attractive for finishing cuts and of particular attention here. Unfortunately, the tradeoff of non-rotation in order to achieve the very fine finish eliminates the benefit of continual refreshing of the edge that comes with a rotating cutting insert. If there were a way to have the fine finish with a round cutting insert that remains non-rotating during a machining operation, while also allowing very quick or automatic indexing of the fixed round cutting insert between machining operations, then the benefits of a rotating cutting insert may in part be realized while also meeting the fine finish requirements that the rotation of the cutting insert cannot meet. That is the subject of the present invention.

Regardless of the shape of the cutting insert, as alluded to just above, the active cutting edge or portion thereof wears out over time of engagement with the workpiece. Between machining operations, the cutting insert must be occasionally indexed to a new, fresh cutting edge (or portion thereof in the case of a round cutting insert); when all cutting edges (or portions thereof) are consumed the cutting insert is replaced. For example, three cutting edges on a triangular insert allows indexing from cutting edge #1 to cutting edge #2, then from cutting edge #2 to cutting edge #3, then the cutting insert is replaced; if the cutting insert has a second side, having three more useable cutting edges, then the insert is flipped after consuming cutting edge #3 and indexing from cutting edge #4 to #5 then to #6 is performed before the cutting insert is replaced. In the case of round inserts, it is indexed to a new, fresh portion (or segment) of the round cutting edge, then when all segments are consumed it is flipped, if the insert has two edges, or replaced if the insert has a single edge.

In all cases, when the cutting insert is a finishing insert, it is common that the wear of the tooth tip results in unacceptable positional error of the new surface created by the tool, though the active cutting edge may still be otherwise capable of more use. In this case, the position of the tooth tip can be adjusted to maintain the needed dimension or position of the new surface. In lathe operations and face milling, for instance, this is done by imposing a wear offset in the CNC controller on the machine so the feeding motion path is shifted slightly. However, in cylinder boring as a one example, the tool cannot be shifted as the rotting tool is creating a hole and shifting the tool would not simply enlarge the hole to compensate for the smaller tool diameter that comes with the wear of the tooth tip(s). In this case, it is common for finishing tools to employ a means of adjusting the finishing insert(s) radially to account for the wear noted, which otherwise causes the hole to gradually become slightly undersized. The present invention allows a novel way of accomplishing this as well for non-round inserts; round inserts provide the same effect in that they often have many useable segments on a single cutting edge that may be indexed to accomplish the same effect of maintaining hole size.

### BRIEF SUMMARY OF THE INVENTION

The present invention provides a means for indexing a round cutting insert to a fresh segment of its cutting edge without loosening the insert retainer (e.g., a screw or clamp) or otherwise disturbing the cutting tool or cutting insert. In a similar embodiment, multiple (say four as an illustrative example) non-round cutting inserts may be indexed from one cutting insert to the next as the means of changing to a fresh cutting edge. This allows rapid, relatively undisturbed operation of the tool for, in this example, four times more machining to take place between the more involved process of indexing each individual cutting insert where its respective insert retainer is loosened/removed, the cutting insert then being rotated or flipped, and the insert retainer reinstalled/retightened, all these activities typically including removing the tool from the machine. In the case of the present invention, after indexing across the four cutting inserts, then the four cutting inserts would be indexed themselves each to a fresh cutting edge, and another four indexes of the four cutting inserts could be done, and so on, until all cutting edges on the four inserts are consumed, at which point the four cutting inserts would be replaced. Finally, since the present invention allows indexing non-round cutting inserts, it can also by way of its configuration, allow adjustment as a means of wear compensation on cylinder boring tools. In fact, the same adjustment approach may be used on a face mill to precisely align all finishing teeth so their respective tooth tips are at the same depth-of-cut position, eliminating what is often referred to as axial runout. In the case of round cutting inserts on cylinder boring tools, rotating to a fresh edge, of which there are typically many on a round finishing insert (e.g. 8-20 depending on conditions), the indexing motion itself leads to maintaining the desired bore size.

### BRIEF DESCRIPTION OF THE DRAWINGS

FIG. 1 is a face mill as an example illustration, with the flank surface and rake surface called out, in a conventional radial mounting of a round cutting insert.

FIG. 2 is a face mill as an example illustration, with the flank surface and rake surface called out, in a tangential mounting of a round cutting insert.

FIG. 3 is a tangential-mount turning tool of the present invention.

FIG. 4a is a tangential-mount turning tool of the present invention in a partial-section view through the insert and rotor axes in a plane including the tooth tip showing a rotary-locating finger engaging the active rotary-locating target.

FIG. 4b is a tangential-mount turning tool of the present invention in a full-section view normal to the insert and rotor axes in a plane including the gear (worm) axis.

FIG. 5 is a rotor showing a plurality of rotary-locating targets on the bottom of the rotor.

FIG. 6 is a tangential-mount turning tool of the present invention in a partial-section view through the insert and rotor axes in a plane including the tooth tip showing a rotary-locating sensor and light-emitting indicator.

FIG. 7a is a top view of a tangential-mount face mill showing a motorized means of rotating the gear that engages the rotor.

FIG. 7b is a front view of a tangential-mount face mill showing a motorized means of rotating the gear that engages the rotor.

FIG. 8a is an oblique view of a boring tool with a rotor holding multiple cutting inserts for indexing and also permitting adjustment of the active insert's depth-of-cut position.

FIG. 8b is an end view of a boring tool with a rotor holding multiple cutting inserts for indexing and also permitting adjustment of the active insert's depth-of-cut position.

FIG. 9a is a one-sided tangentially-mounted cutting insert.

FIG. 9b is a one-sided tangentially-mounted cutting insert mounted to a rotor.

FIG. 9c is a two-sided tangentially-mounted cutting insert mounted to a rotor.

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

### DETAILED DESCRIPTION OF THE INVENTION

The present invention is a fine-finishing tool that, along with the method for its use, allows achieving a fine surface finish (low surface roughness) at much higher feed rates than with conventional tools and methods of their use. Like conventional finish machining operations where a small depth of cut is employed, the tool and method of the present invention also involve a small depth of cut. However, due to the large radius of curvature at the tooth tip, and surface roughness being proportional to feed squared and inversely proportional to the tooth-tip radius of curvature, the increase in radius of curvature with the present invention allows the feed to be increased significantly. With a tangential-mount insert of 25 mm diameter, set at angles allowing depth of cut similar to conventional finishing operations, the tooth-tip radius of curvature is in the range of 120 mm to over 300 mm. Compared to a typical 0.8 mm corner radius, and taking the square root of the radius ratio, the feed with the present invention can be 12 to 20 times the feed one would take with a conventional (0.8 mm corner radius) cutting insert. Even compared to a conventional radial mounting of a 12 mm diameter round cutting insert, the square root of the radius ratio indicates a feed multiplier of 4 to 7 times. While such increases in feed proportionally increase productivity (cutting speed and depth of cut held constant), it also results in proportionally less insert-workpiece contact per part machined, which proportionally increases tool life.

To take the advantage of increased tool life further, the present invention offers the ability to very quickly index a round cutting insert when the current tooth tip has become more worn than is acceptable to produce a satisfactory surface, either in surface roughness or dimension or positional location. The indexing involves rotating the rotor, to which the cutting insert is and remains affixed during the indexing action, by a specified angle. Regarding the insert remaining affixed to the rotor, this is in contrast to what is required to index a conventional cutting insert on a conventional cutting tool. In the conventional case, for each cutting insert on the tool, one must manually loosen an insert retainer, such as a clamp, or more commonly in present technology full removal of a small screw, in order to index a cutting insert to a fresh cutting edge. In the present invention, the round cutting insert can be indexed many times between changing to a fresh cutting insert (i.e., between the need to loosen the insert retainer(s)), each index being done in a fraction of the time, and also not requiring excessive cleaning of the tool and cutting insert mounting surfaces as is needed when indexing a conventional cutting insert.

Some embodiments allow the indexing to be done automatically without direct human intervention. That is, the indexing actuation can be done with a motor integrated into the cutting tool rather than manually by engaging an actuation tool. Finally, by employing an electronic rotary-locating sensor to serve as an indicator of how much the round cutting insert has been rotated, the specified angle associated with the index may be optimized by programming the electronics according to the feed and depth of cut being used. And furthermore, with the ability to rotate the rotor by any specified angle in this case, the present invention allows one to mount a non-round cutting insert (or a round cutting insert as the case may be), by positioning the axis of the rotor to be offset from the axis of the cutting tool, one can perform small adjustments to account for geometric changes to the tooth tip that occur as the tool/cutting-edge/tooth-tip wears. This is useful for cylinder boring tools, in particular. In fact, the present invention allows multiple cutting inserts to be mounted to the rotor so that, once the active tooth tip is worn beyond what small adjustments (wear offsets) can correct, the rotor can be rotated by a larger specified angle, such as (nominally) 90 degrees in the case of four cutting inserts evenly distributed around the rotor, to effectively index to a fresh cutting edge on one of the other (e.g., the other three) cutting inserts on the rotor.

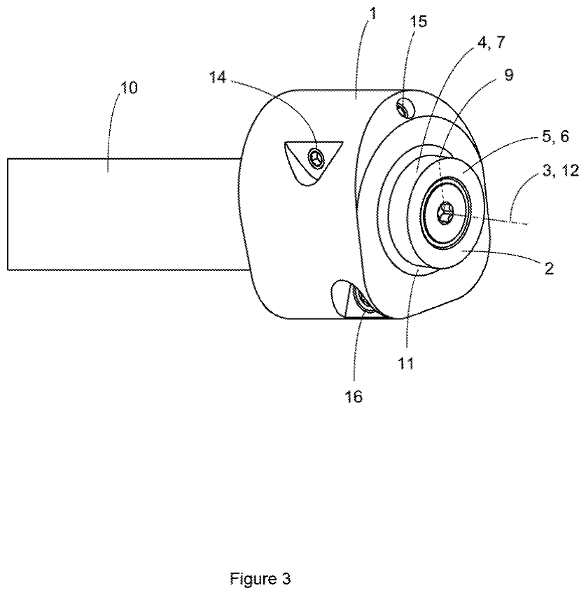

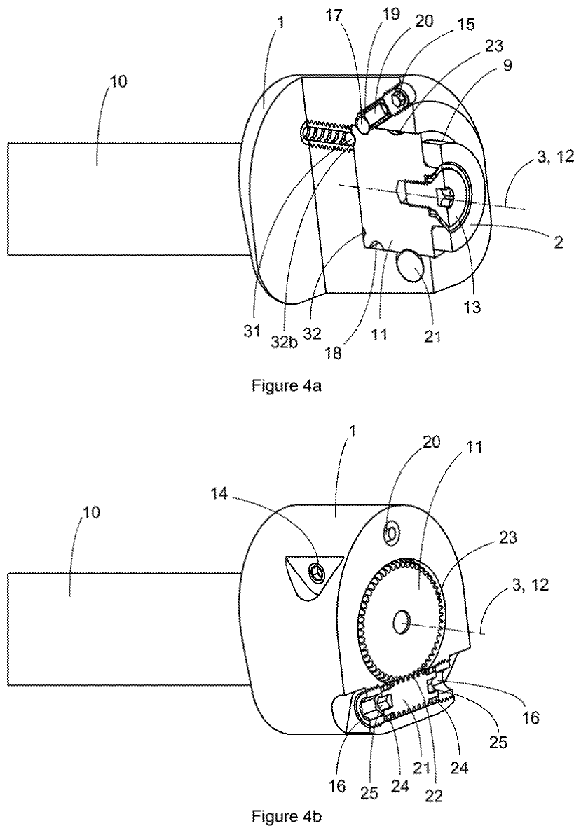

A first embodiment of the cutting tool is shown in FIG. 3. This is a lathe tool with a single cutting insert 2. As with any cutting tool, it has a body 1 to which the cutting insert 2 is attached by way of an insert retainer 13, and a machine interface 10, for a turning tool often being referred to as the shank. FIGS. 4a and 4b show additional sectioned views in which the internal components, being sealed and protected from the outside operating environment, can be seen. In this embodiment a rotor 11 is held into the body 1 by way of a locking pin 17, which is retained in the body 1 by a locking-pin retainer 14, a set screw in this case shown. The locking pin 17 engages the rotor in a locking-pin groove 18. Positive force is maintained on the locking pin 17 by way of a clamping spring 19 compressed by a clamping screw 15. Within the clamping spring 19 is a clamping pin 20. In some applications it may be desirable to more securely lock the rotor 11, more so than the clamping spring 19 can do on its own under its compressed spring force. In these cases, further tightening of the clamping screw 15 mates with and compresses the clamping pin 20 so it rigidly mates with the locking pin 17. This is also useful for the purpose of restraining the torque associated with loosening and tightening the insert retainer 13 when the cutting insert 2 is fully consumed and needs to be flipper or changed to a fresh cutting edge 8. The cutting insert 2 is mounted to the rotor 11 such that its insert axis 3 is substantially coaxial/aligned with the rotor axis 12.

The rotor 11 is rotated by a specified angle by way of a gear 21 with gear teeth 22 that mate with rotor teeth 23 on the rotor 11. In this embodiment, gear 21 is a worm and rotor teeth 23 are those of a worm wheel. Other types of gears may be employed, such as but not limited to bevel gears, spur gears, and helical gears or combinations thereof. When the rotor 11 is rotated, tooth-tip 9 does not change its depth-of-cut position, which in this figure is measured in the direction parallel to the length of machine interface 10 (the shank). As shown, the gear 21 (worm) is retained into the body 1 by a gear retainer 16. As a convenience, allowing access to the worm for actuation, the gear is further retained into the body 1 by a second gear retainer. Otherwise, the hole in which the gear 21 resides could be a blind hole allowing access, and means for insertion during assembly, on only one side. Between each gear retainer 16 and gear 21 is a gear seal 24. Also shown on each end of gear 21 is an actuation interface 25. In the case shown for illustration, the actuation interface 25 is a socket for a hex key; it could be a socket for a Torx® key, or a pair of holes for a two-pined key, or other means of transmitting torque from an actuation tool (not shown) and the gear 21. In the figure shown, gear retainers 16 are “hollow-lock” set screws, which provide an opening coaxial with the screw's axis, through which the actuation tool (not shown) engages the actuation interface 25.

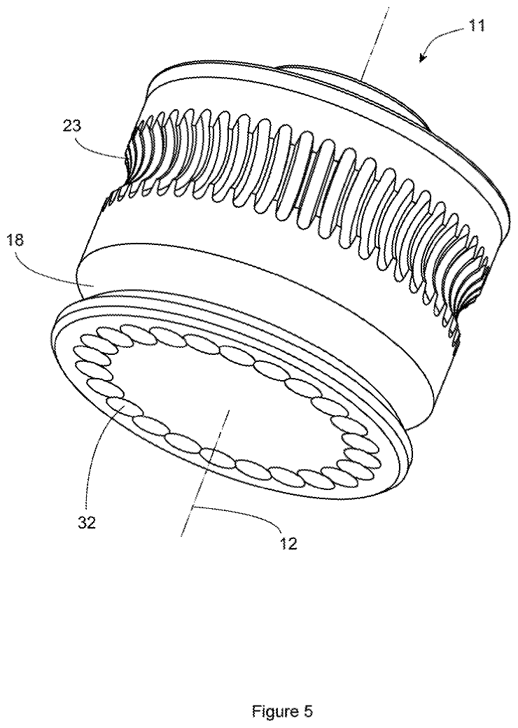

FIG. 5 shows the rotor 11 in detail. Referring to FIGS. 4a and 5, in this embodiment, the specified angle is indicated by way of a rotary-locating finger 31 attached to the body 1, which engages one of a plurality of rotary-locating targets 32 (specifically, the active rotary-locating target 32b, see FIG. 4a). In the embodiment shown, the rotary-locating finger 31 is a ball-nosed spring plunger. There are other means of accomplishing this engagement, generally involving a sprung element, referred to here as the rotary-locating finger 31, mechanically engaging the active rotary-locating target 32b, which serves as an indicator that the specified angle has been reached, the engagement activating the indicator, which provides a tactile and/or audible signal that is sensed by the person who is manually actuating the gear 21. While this is representative of a mechanical engagement and activation of the indicator, other embodiments may employ an interaction between the rotary-locating finger 31 and the rotary-locating targets 32 in a way that involves mechanical contact that results in opening and closing of an electrical circuit that serves as the indicator that the specified angle has been reached; the opening or closing of the electrical circuit being the activation of the indicator. In the case of there being an electrical circuit, that circuit would include a light-emitting element, sound-producing element, or tactile signaling element (e.g., vibration source).

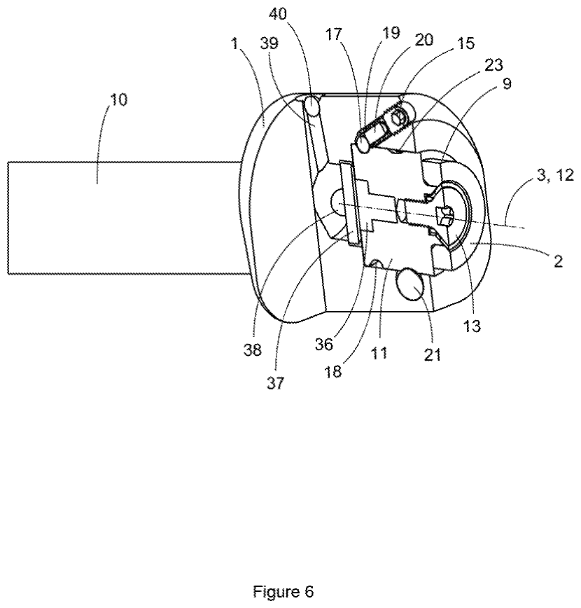

This leads to another embodiment where the sensing of rotor angle is achieved with an electronic sensor instead of the rotary-locating finger of the previous embodiment. Shown in FIG. 6 is this embodiment where the sensor includes a rotating sensor element 36 and a stationary sensor element 37. The rotating sensor element 36 and stationary sensor element 37 may be mechanically/physically connected such as with a potentiometer, or non-contacting such as a magnetic sensing method like a Hall Effect sensor/encoder. There are various other types of sensors that may be employed, such as an optical encoder. In any embodiment making use of an electrical circuit as the indicator that the specified angle has been reached, it would include a means to relay that electrical signal to the human who is manually actuating the gear 21. Shown in FIG. 6 is a light-emitting element 38 and an indicator conduit 39 and indicator lens 40, which would be made of a transparent or semi-transparent material. Instead of a light-emitting signal, or in addition to a light-emitting signal, could be an electronic audible signal, such as but not limited to a buzzer or ringing bell, and/or a tactile signal such as a vibration. Not shown is a small battery that powers the electronics, which can be located as is convenient, such as in the machine interface 10 (shank).

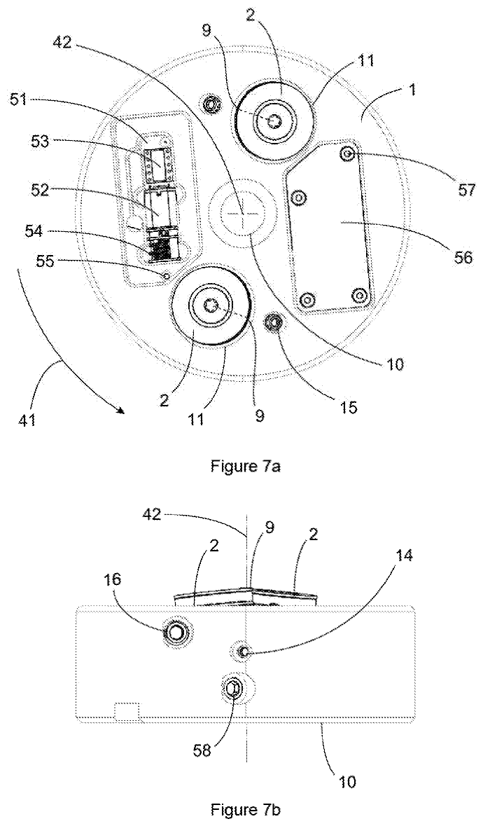

Another embodiment, shown in FIGS. 7a and 7b, introduces along with the electronic circuit for sensing rotor angle, a motor 52 as the means to actuate the gear 21. This embodiment is also an example of a rotating cutter, a face mill, which experiences rotational cutting motion 41. The sensor is still housed beneath the rotor 11 with the electrical communication to the motor 52 and its related electronic components, located in a motor compartment 51, by way of wires that are routed through a wire channel that is closed off after assembly by wire-channel cover 58. Also in the motor pocket are components that are generally necessary for motor actuation, such as but not limited to a motor controller 53 and a speed reducer 54. The torque from the motor 52 actuates the gear 21 by way of the actuation interface 25 (not visible), access to which for connection purposes is enabled by an actuation interface port 55. On the right side of FIG. 7a is shown the motor compartment cover 56 and the means of fastening it to the body 1, the motor cover retainers 57, in this case four screws. With the inclusion of a motor, a larger battery is needed than in the previous embodiment; not shown is a battery compartment associated with each cutting tooth, sensor, and motor 52, located on the back side of the body 1 (not shown). In a non-motorized face mill, the smaller battery noted in the previous embodiment that is needed only for sensing and signaling would be located in a smaller battery compartment in the body 1. This embodiment shows two cutting teeth; larger cutters may have more than two, or only one. A face mill of a given cutting diameter can hold more teeth in the case of manual actuation instead of motor actuation.

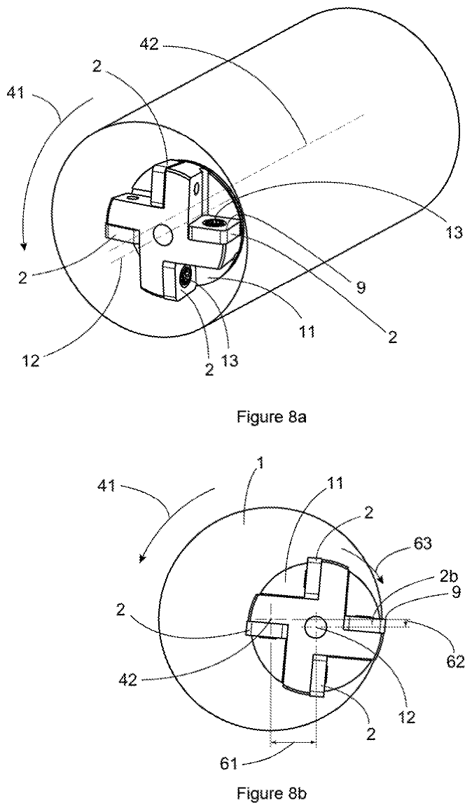

The next embodiment is a cylinder boring tool, which experiences rotational cutting motion 41, as shown in FIGS. 8a and 8b, though it could be applied to other tools as desired, such as to adjust multiple cutting teeth on a face mill so they each have their tooth-tip precisely matched in the depth-of-cut direction. The shown embodiment employs the same rotor 11 (one or more), but instead of a single round cutting insert attached to each rotor 11 with insert axis 3 aligned with rotor axis 12, multiple cutting inserts 2, generally non-round but they could be round, are distributed around the rotor 11, generally evenly distributed. By locating the rotor axis 12 relative to the body axis 42, offset by a radial rotor offset 61, and tangential rotor offset 62, when the rotor 11 is rotated in the indexing direction 63, small angles of rotation cause the active cutting insert 2b to move radially, increasing the radial position of the tooth-tip 9. This allows geometric deviation due to tool wear to be compensated, or as noted, for micro alignments of multiple teeth on a cutting tool. The rotor 11 may be actuated, by way of gear 21 (not shown), either manually or by way of a motor that can be housed in the body 1.

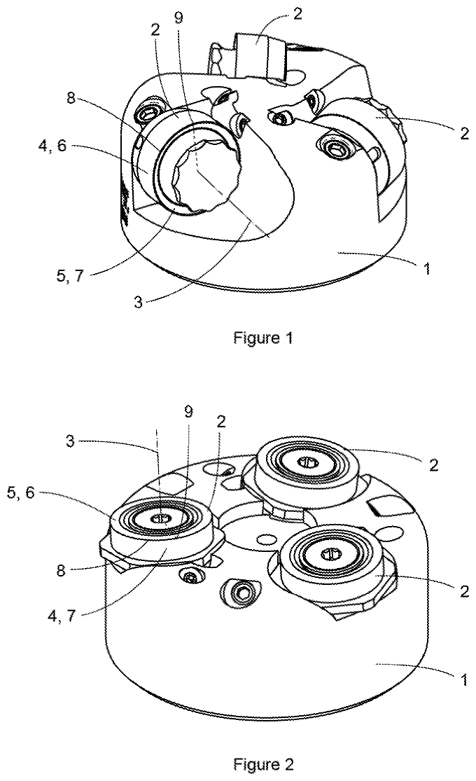

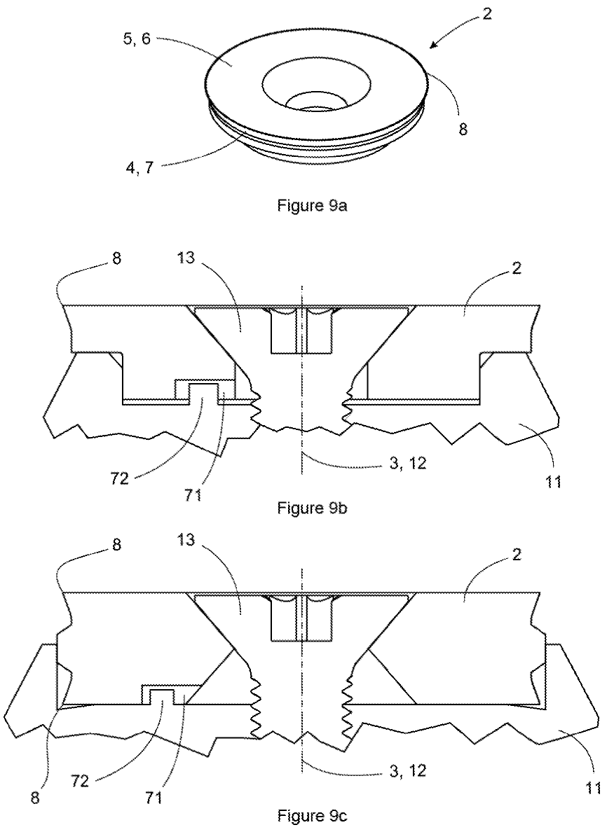

Shown in FIGS. 9a, 9b, and 9c are section views of typical round tangentially-mounted cutting insert 2, including their interface with the rotor 11. In particular, shown is a receiver 71 on the insert 2 that engages a protrusion 72 on the rotor 11. The engagement is a lose slip fit in the direction normal to the page. The protrusion 72 could instead be on the cutting insert 2 with the receiver 71 on the rotor 11. This protrusion-receiver interface is important to assure the cutting insert 2 does not rotate relative to the rotor 11; if a relative rotation occurs then the indexing, or rather the rotary-locating value, of the cutting insert 2 is corrupted. Furthermore, if the relative rotation is in the direction that would loosen the insert retainer 13, then the cutting insert 2 might loosen and cause damage to the workpiece or tool or machine. FIG. 9a, specifically, shows the respective surfaces noted earlier in respect to FIG. 2 for a tangentially-mounted round cutting insert. Top end surface 5 serves as the flank surface 6 and peripheral surface 4 serves as the rake surface 7, the intersection of which form the round cutting edge 8.

The final element of the present invention is the method by which a tool as described thus far is used to remove an existing, physical first surface from a workpiece, creating a physical new/third surface on the workpiece on which a low surface roughness is achieved while employing an unconventionally high feed. The method comprises the following steps.

1. Defining a virtual second surface, which is substantially equivalent to the desired final new/third surface in size, shape, and position.

2. Defining the path of the cutting tool as a series of points, as is typical in defining a tool path via CAM or via G-code programming, from a start point to an end point, all points being on the virtual surface (desired final surface to be created) defined in step 1. Of course, as is typical, there may be a cutter radius offset imposed in this relation between the path of the tool and the desired final new surface to be created.

3. Defining the rate of feeding motion between adjacent points on the path defined in step 2 based on the desired feed per finishing tooth on the cutting tool. For at least one pair of adjacent points, this feed per finishing tooth should be greater than the depth of cut experienced anywhere between the adjacent points, the depth of cut measured to the first surface. This high feed per tooth, being greater than the depth of cut, is where the present invention departs from conventional finish machining methods.

4. Installing a fresh cutting insert in the appropriate teeth, the finishing teeth, on the cutting tool.

5. Providing a cutting motion to the cutting tool or workpiece, whichever is rotating by way of the spindle by turning on the spindle.

6. Initiating the tool feeding motion, which will follow the tool path in a substantially tangential fashion, point to point according to how CNC controllers work.

7. Repeating steps 5 through 6 on multiple workpieces, until the active cutting edge(s) are worn out.

8. Rotating the rotor such that a new active cutting edge, or segment thereof is in the tooth-tip position.

9. Repeating steps 5 through 8 until all useable edges or segments thereof are consumed.

10. Replacing the worn cutting inset with a fresh one in the appropriate teeth (the finishing teeth), as was done in step 4.

11. Repeating steps 5 through 11.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A device for mechanically removing material, the device comprising:
a. a body;
b. at least one cutting tooth comprising:
i. a rotor that is rotatable about an axis;
ii. at least one cutting insert having at least one cutting edge having a tooth tip;
iii. one insert retainer corresponding to a respective cutting insert whereby the respective cutting insert is affixed to the rotor;
iv. a means of holding the rotor stationary in all degrees of freedom relative to the body during a machining operation thereby locating one tooth tip at a depth-of-cut position; and
v. a means of imparting an angle of rotation to the rotor by a specified angle between two subsequent machining operations without loosening any one of the insert retainers.

2. The device of claim 1, further comprising a rotary-locating finger attached to the body and a plurality of rotary-locating targets on the rotor that are spaced according to the specified angle, whereby the rotary-locating finger engages an active rotary-locating target during the machining operation.

3. The device of claim 2, further comprising an indicator that is activated when the rotary-locating finger engages the active rotary-locating target.

4. The device of claim 3, in which the indicator is emitted light that changes its emission when activated.

5. The device of claim 1, further comprising a rotary-locating sensor whereby the angle of rotation is sensed.

6. The device of claim 5, further comprising an indicator that is activated when the angle of rotation sensed by the rotary-locating sensor reaches the specified angle.

7. The device of claim 6, in which the indicator is emitted light that changes its emission when activated.

8. The device of claim 1, in which the means of imparting the angle of rotation to the rotor includes a gear having teeth that engage mating teeth on the rotor.

9. The device of claim 8, in which the gear is a worm and the teeth on the rotor are teeth of a worm wheel.

10. The device of claim 8, in which the gear is a spur gear.

11. The device of claim 8, in which the gear is a helical gear.

12. The device of claim 8, further comprising an actuation interface on the gear whereby the gear is rotated using an actuation tool that engages the actuation interface between the subsequent machining operations.

13. The device of claim 8, further comprising a motor whereby the gear is rotated by way of the actuation interface.

14. The device of claim 1, in which at least of the one cutting inserts is a finishing insert comprising:
a. an insert axis;
b. an upper end having a surface axisymmetric about the insert axis;
c. a lower end having a surface axisymmetric about the insert axis;
d. a peripheral surface symmetric about the insert axis;
e. a circular cutting edge at the intersection of the upper end surface and the peripheral surface; and
f. a central hole passing from the upper end surface through to the lower end surface.

15. The device of claim 14, further comprising at least one receiver on the finishing insert and at least one protrusion on the rotor, wherein at least one receiver mates in loose slip fit with at least one protrusion.

16. The device of claim 15, further comprising at least one protrusion on the finishing insert and at least one receiver on the rotor, wherein at least one receiver mates in loose slip fit with at least one protrusion.

17. A method for removing a physical first surface from a workpiece and creating a physical third surface on the workpiece with a cutting tool comprising a body and at least one cutting tooth comprising:
a. a rotor that is rotatable about an axis;
b. at least one cutting insert having at least one cutting edge having a tooth tip;
c. one insert retainer corresponding to a respective cutting insert whereby the respective cutting insert is affixed to the rotor;
d. a means of holding the rotor stationary in all degrees of freedom relative to the body during a machining operation thereby locating one tooth tip at a depth-of-cut position; and
e. a means of imparting an angle of rotation to the rotor by a specified angle between two subsequent machining operations without loosening any one of the insert retainers;
in which at least one of the cutting teeth is a finishing tooth, the method comprising, steps a through d not necessarily in the sequence described, the steps of:
a. defining a virtual second surface that encompasses in substantial equivalency in size, shape and position the third surface;
b. defining a path comprising an ordered plurality of points having a start point and an end point, in which each point is positioned on the second surface;
c. defining for each pair of adjacent points on the path a feed per finishing tooth greater than a feed-multiplier multiplied by a distance measured anywhere between the respective pair of adjacent points and normally from the second surface to the first surface;
d. installing at least one fresh cutting insert on one of the finishing teeth;
e. providing a rotating cutting motion;
f. providing a feeding motion substantially tangential to the path at a rate corresponding to the feed per finishing tooth;
g. repeating steps e through f on a plurality of workpieces;
h. imparting the specified angle of rotation to the rotor;
i. repeating steps e through h;
j. replacing the cutting insert on at least one of the finishing teeth with a fresh cutting insert; and
k. repeating steps e through j.

18. The method of claim 17, in which the feed-multiplier is equal to 1.0.

19. The method of claim 17, in which the feed-multiplier is equal to 1.5.

20. The method of claim 17, in which the feed-multiplier is equal to 2.0.
